(19) United States
(12) Patent Application Publication
(10) Pub. No.: US 2001/0041199 A1
(43) Pub. Date: Nov. 15, 2001

(54) PROCESS FOR THE CO-MANUFACTURE OF INGREDIENTS FOR USE IN FOODS AND BEVERAGES USING POTATOES AS STARTING MATERIAL

(76) Inventor: STEPHEN J. DAVIDS, QUEBEC (CA)

Correspondence Address: STEPHEN J. DAVIS, 880 AV CASOT APP. 1, QUEBEC, QC, G1S 2X9, CA

(21) Appl. No.: 09/268,635

(22) Filed: Mar. 16, 1999

Related U.S. Application Data
(63) Continuation-in-part of application No. 08/958,138, filed on Oct. 28, 1997, now abandoned.

(30) Foreign Application Priority Data
Oct. 30, 1996 (CA) 2,189,268

(51) Int. Cl. C12C 11/00

(52) U.S. Cl. 426/11

(57) ABSTRACT

Disclosed is a process for the co-manufacture of ingredients having food and beverage applications, using potatoes as starting material. The process comprises six steps. The first step is a cutting and dipping of washed raw potatoes in an anti-oxidant solution. The second step is an extraction of undiluted juice free of starch and fibers from a purée made from the anti-oxidant-dipped raw potatoes. The third step is a concentration and enzymatic treatment of the juice. The fourth step is a heating of the juice to specific temperatures to cause precipitation of proteins and separation of precipitated protein therefrom. The fifth step is a thermal browning of the clear juice. The sixth step is an adjustment of the final pH of the juices of the fourth and fifth steps and a blending of these juices in ratios appropriate for intended use. These six steps yield products which may be used as the main flavor principle in malt-free beer, as a coffee substitute and as a flavor enhancer in savory mixes. They also yield dietary fibers, a concentrated edible protein and non-gelatinized granular starch, thereby increasing revenues derived from potato processing while minimizing liquid waste stream.

### CROSS-REFERENCE

The present application is a continuation-in-part of application Ser. No. 08/958,138 filed on Oct. 28, 1997.

### FIELD OF THE INVENTION

The present invention is concerned with the use of potatoes for the co-manufacture of novel, valuable ingredients for use in the food and beverage industries while substantially reducing the organic load of the waste stream. The ingredients that are so manufactured can be used as a main flavour principle in a malt-free beer, as a coffee substitute and/or as a flavour enhancer in savoury mixes. Other ingredients that are obtained as by-products include dietary fiber, concentrated edible protein as well as granular starch.

### BRIEF DESCRIPTION OF THE STATE-OF-THE-ART

Potato Processing and Waste Water Treatment

Potatoes derive most of their value either from their direct use as food or from the starch they contain. In the conventional production of non-gelatinized starch (also called “granular” starch) from potatoes, starch is the only saleable product recovered. The residual fibrous pulp from potato starch production is given away to local cattle raisers or dairy farmers while the intracellular proteins, sugars and salts are diluted and lost in water used to flush starch from the pulped potatoes, generating a polluting waste known as “potato fruit water”. Various methods have been developed for recovering the organic matter from potato fruit water. They include heating to recover the protein as denatured protein isolate, fermentation to recover the free amino acids, sugars and salts in the form of yeast biomass, and various other combined treatments. In a recent method taught by Olsen in U.S. Pat. No. 5,573,795, enzymes are used to digest proteins to low-molecular mass substances in heat-sterilized fruit water. The treated water can be concentrated to over 50% solids to ensure microbiological stability and used as a protein source in animal feeds.

Products derived from potato fruit water are limited for use as animal feed because the potatoes used for starch production are low-cost and therefore often of poor microbiological quality. Since thermal destruction of contaminating microorganisms cannot restore fruit water to a food-grade state, it has been assumed so far that nothing of high enough value can be obtained to justify paying for better quality starting material. Low-cost starting material also requires the potato starch operation to begin with a very robust, stone-resistant disintegrating device. Such a device does not liberate sufficient free-flowing juice from the potato pulp to allow instant separation of the fibrous portion from the starch, thereby necessitating the use of flushing water and hence juice dilution.

Beer-making

The main starting material for the production of the beverage known as beer is barley or wheat which is made to germinate to produce what is known as malt. Malt may be roasted to develop its flavour. Brewers grind malts and suspend them in water at temperatures which activate enzymes naturally present leading to the conversion of starch and protein into fermentable sugars and free amino acids respectively. A liquid extract containing these is separated from the spent grain and boiled for one or two hours with hops or other plant tissues to pick up aromas and flavours, especially bitter flavour notes. The spent hops are removed and the resulting liquid, called wort, is cooled and inoculated with a yeast such as Saccharomyces cerevisite or Saccharomyces carlsbergensis. During the ensuing fermentation, the yeast converts sugars into alcohol and carbon dioxide. When fermentation is complete, the yeast is removed by filtration or allowed to settle. The alcohol-containing liquid essentially free of yeast may now be called beer. As a finishing step, the beer may be allowed to stay for a few weeks at low temperature to improve its flavour.

Numerous variations on this process are known. The factors having the most impact on beer flavour include the type of malts, hops or spices used, the initial sugar concentration in the wort, the fermentation temperature, the yeast type, bottling with extra yeast and sugar to produce gas pressure, post-fermentation infusions and so on. Corn syrup, honey, glucose solids and other useful nutritional elements, collectively known as adjuncts, may be incorporated into the wort added during the boiling step. These serve primarily to increase the amount of sugar available for conversion into alcohol but may also provide nutrients to sustain yeast growth. The use of potatoes as brewing adjunct is also known. The conversion of whole potatoes into a maltose syrup for use as brewing adjunct is taught by Janser et al in United Kingdom patent No. 569,597. In this process, potatoes are cooked and starch is gelatinized to facilitate its conversion into maltose by added enzymes. The residue from this process is a sludge recovered by centrifugation, consisting of an unseparatable mass of cooked fiber, protein and dilute syrup.

Coffee Substitutes

Periodic coffee shortages and consumer need for a warm, unctuous caffeine-free beverage, have both spawned a beverage category known as coffee substitutes. These are made of materials extracted from malt and include powdered molasses and chicory as ingredients. They are packaged as powders for instant use and simply reconstituted in hot water.

Meat-flavour Enhancement by Hydrolyzed Vegetable Protein

Flavour enhancement in meat-based foods and in savoury mixtures for soups, sauces and snack foods is achieved in large part using a product known as hydrolyzed vegetable protein or HVP. This product is obtained industrially from protein sources such as corn and wheat glutens or from soy protein isolate by subjecting them to temperatures of at least 120° C. in 6M hydrochloric acid for hours, neutralizing the acid and drying the product to powder. This process hydrolyzes the proteins to a mixture of free amino acids, of which glutamic and aspartic acids are the most important for flavour enhancement purposes. Both consumers and regulatory agencies are starting to pressure manufacturers of commercial flavour mixtures into finding alternatives to HVP, because of the possibility that some chlorinated residues resulting from intense hydrochloric acid hydrolysis may pose a health hazard.

The Maillard Reaction

It is well known that the desirable flavours and colours characterizing dark malts and coffee are both the result of a thermal reaction between reducing sugars and amino acids known as the Maillard reaction. This reaction also contributes roasted flavour notes in cooked meats and important flavours in soya sauce. It is also known that the Maillard reaction occurs in potatoes, especially during deep-frying of chips or french-fries and can occur in potato fruit water heated to high temperatures for long periods. This reaction is considered undesirable in these latter cases.

### SUMMARY OF THE INVENTION

It has now been discovered, and is the object of the present invention, that a juice free of starch and fiber extracted from raw potatoes and treated as disclosed hereinafter provides an ingredient with which malt-free beer can be brewed. It is currently recognized that the protein known as gluten, contained in all foods and beverages made with cereals such as barley, wheat, rye, oats and triticale, causes illness in persons afflicted with a condition known as the coeliac disease. People with the coeliac disease must follow a strict gluten-free diet and rely heavily on potatoes and corn as sources of carbohydrate. It has been demonstrated that people with coeliac disease enjoy beer made from potato wort according to this invention without suffering any ill effects.

It has also been discovered, and is another object of the invention, that one can employ the Maillard reaction to treat a juice extracted as disclosed hereinafter for the purpose of producing highly palatable flavours in malt-free beer.

It has further been discovered, and is a further object of the invention, that one can also take advantage of the Maillard reaction to treat a juice extracted from potatoes and treated as disclosed hereinafter for the purpose of producing a powder which may be considered to be a caffeine-free instant coffee substitute.

It has still further been discovered, and is another object of the invention, that one can further take advantage of the Maillard reaction to treat a juice extracted from potatoes and treated as disclosed hereinafter for the purpose of producing a powder having a roasted-meat-hydrolyzed-vegetable-protein taste.

The process of the invention allows the Maillard reaction to be carried out separately from the potato protein and thereby to conserve the nutritional quality of this protein.

The object of the present invention is therefore to provide a process using potatoes as a starting material for the manufacture of ingredients which may be used to make a malt-free beer and caffeine-free coffee substitute. This same process may also be used to manufacture a substitute for hydrolyzed vegetable protein. Dietary fiber, an edible protein isolate and granular starch are co-manufactured separately. The invention therefore allows six saleable co-products to be produced within a potato processing facility.

More specifically, the process according to the invention for the manufacture of ingredients having food and/or beverage applications using potatoes as a starting material, comprises the steps of:

a) cutting washed raw potatoes and dipping the so-cut potatoes in an antioxidant solution;

b) mechanically disintegrating the cut and dipped potatoes obtained in step a) whereby fiber and a starch-containing juice are obtained, separating the fiber from the starch-containing juice and processing said starch-containing juice to extract the juice from the starch, said starch being in a non-gelatinized form;

c) subjecting the so-extracted juice to a slow evaporation with or without simultaneous addition of extra enzymes to produce small proteins and free amino acids from proteins contained in the juice;

d) heating the juice obtained in step c) to precipitate soluble proteins and to destroy enzymes contained in it, and separating by filtration the precipitated proteins from the juice to obtain a protein isolate and a filtered juice;

e) optionally further heating protein of the filtered juice obtained in step d) to a temperature high enough to cause a Maillard browning reaction;

f) adjusting the pH of the juice(s) obtained in step d) and in optional step e) and, when a portion of the juice has been subjected to the further heating of step e), blending said portion of the juice with the remainder of the juice obtained in step (d) in a preselected ratio; and

g) recovering at least one ingredient, at least one of the following products:

(i) the fiber obtained in step b), which is edible;

(ii) the non-gelatinized starch produced in step b);

(iii) the protein isolate obtained in step d), which is edible; and

(iv) to (v) the juice obtained in step f) which:

when all the filterated juice obtained in step d) has been subjected to the further heating of step e), is useful to make a caffeine-free coffee substitute;

when none of the filterated juice obtained in step d) has been subjected to the further heating of step e), is useful as a hydrolyzed vegetable protein substitute; and

when a portion only of the filterated juice obtained in step d) has been subjected to the further heating of step e) and said portion has been blended with the remainder part of the juice obtained in step d), is useful to make a fermentable wort to produce a malt-free beer.

Other objects of the invention are the beer-making ingredients, the coffee substitute and the hydrolyzed vegetable protein substitute produced by the above process.

The invention and its advantages will be better understood by reading the following general and not limiting description.

### GENERAL DESCRIPTION OF THE INVENTION

Step (a): Processing of the Potatoes

Potatoes may be stored under different temperature conditions in order to favour saccharification of the juice or development of other useful enzyme activities such as proteolysis associated with germination. Regardless of the type of storage, well-scrubbed tubers must be cut into at least two pieces but not more than eight pieces, and dipped in an anti-oxidant solution. Tubers may also be peeled abrasively. This reduces the amount of anti-oxidant required to prevent enzymatic browning but some usable material is lost. Caustic peeling increases the salt content of the wort. Steam peeling causes gelatinization of starch at the surface of the tubers and fouls subsequent filtration steps.

The cut potatoes may be dipped in solution at any temperature between 0° C. and 22° C. for a period between 2 and 30 minutes. An aqueous solution of any sulphurous anhydride-producing substance may be used, preferably at a concentration between 10 and 20 g/l. Sodium or potassium sulphite, bisulphite and pyrosulphite are examples of suitable substances for the dipping. About 0.5 liter of solution per kilogram of potato is sufficient to completely submerge the pieces.

Step (b): Extraction of the Juice

Extraction of the juice is done by finely disintegrating the dipped pieces of potato to produce a free-flowing purée, centrifuging the purée to separate the fibrous pulp portion, viz. the fiber, from the starch and juice portion and drawing the juice through a filtering bed made by the starch which has sedimented from the juice. A centrifugal juicer is preferably used to simultaneously carry out the disintegration of the potato pieces and separation of the fibrous portion. The latter may be passed through the juicer repeatedly to increase the yield of juice and starch. Undiluted juice is obtained using such a device. The fibrous portion may be washed and pressed to remove traces of juice and air-dried, followed by reduction to fine powder by conventional mechanical means. It is then useful as a source of fiber, for example in baked products.

The starch-containing juice is collected in a container equipped with a perforated false bottom covered with cloth suitable for vacuum filtration. This cloth may be a smooth polyester fabric which retains starch granules and small fibrous particles but lets protein-containing juice pass. After a while, a dense and stable layer of starch and fibrous debris forms on the cloth, which acts as a filter and partially clarifies the juice as it passes through.

Depending on the state of the potatoes resulting from their storage, from 5 to 8 liters of juice may be obtained from 10 kg of dipped potato pieces, using a 30 mm Hg vacuum over a 1 500 cm² filter surface. The friable, starch filter cake thus retained on the cloth contains 60-65% solids.

Step (c): Evaporation and Enzymatic Treatment of the Juice

The juice obtained in step (b) is subjected to a slow evaporation by warming it to a temperature between 45° C. and 60° C. The pH of the juice that is being warmed is adjusted to a value between 4.0 and 5.5 using an acid such as phosphoric, citric, lactic, acetic or hydrochloric acid, or a cationic exchange resin which acidifies the juice by exchanging hydrogen ions for potassium ions. Alternatively, use can be made of part of the heat-treated juice obtained in step (e) hereinafter to adjust the pH to the required value. After such temperature and pH adjustments, the juice is microfilterable. It is advantageous to transfer the juice aseptically into a sterilized incubation vessel across a sterilized microfilter. The juice thus sterilized by microfiltration may be incubated for prolonged periods of time under conditions of pH and temperature which would otherwise be permissive to the growth of contaminating microorganisms. Extra proteolytic enzymes or proteolytic microbial culture may be added to the juice prior to microfiltration. The juice is incubated for up to 48 hours under temperature and pH conditions suitable for the desired activity of the enzymes. Advantageously, the incubation vessel may be connected to a vacuum source in order to increase evaporation during incubation and to remove oxygen which would otherwise cause enzymatic browning. Sulphurous anhydride is also lost by volatilization, leaving sodium or potassium as counter ions to citrate and drawing the pH upward. Acetic acid used to lower the pH for microfiltration is also lost, with the same effect on the pH. This is advantageous in some cases.

Step (d): Precipitation and Separation of Proteins in the Juice

After step (c), the juice is heated to terminate all enzymatic activities and precipitate some portion of the proteins in the juice. Temperature and pH conjointly determine the amount of proteins precipitated. At 50° C. and pH 5.0, up to 50% of the proteins may be precipitated while at 70° C. and pH 5.5, at least 80% of them are precipitated. Preferably, a temperature is selected in the range between 60° and 100° C. Boiling the juice at any pH precipitates all of the native protein while lower molecular mass peptides remain in solution and may precipitate only upon cooling to refrigerator temperatures. The amount of proteins remaining in the juice determines foam stability, which is important for beer-making applications.

The precipitated proteins are separated by filtering the juice on a suitable porous cloth or paper or combination thereof, by mechanically pressing or by combination of both of these techniques. The precipitate which is white-to-beige becomes dry to touch on the filter and is rinsed with a small volume of clean water and then air-dried. It is then microbiologically stable and can easily be reduced to powder. The powder may be dried to less than 10% moisture for use as edible proteins, for example in baked products. The clear, yellowish filtered juice thus obtained may be concentrated to 25-60% solids, depending on the sugar content. Higher sugar content allows a higher solids content because of the high solubility of sugars.

Step (e): Thermal Browning OF the Juice

The clear, yellowish juice obtained in step (d) or a portion thereof is placed in a shallow plastic container (Teflon, for example) and subjected to an optional further heating treatment carried out in a drying oven at 100-140° C. The initial pH of the juice may be raised to 8.0 using a carbonate or hydroxide of sodium or calcium, if desired. The drying of the juice must occur rapidly enough not to allow wild microorganisms to proliferate, but not so rapidly that charring occurs. Alternatively, the juice may be autoclaved in a flask at temperatures from 120° C. to 135° C. for up to two hours. Either treatment causes an intense Maillard reaction, during which reducing sugars react with free amino acids and peptides to produce brown colours, flavours and desirable antioxidant properties. The exact flavour characteristics, colour, texture and final pH resulting from thermal browning are influenced by the type of storage of the starting material, the nature of the enzymatic step and the degree of reaction achieved during the thermal treatment. The latter factor varies primarily as a function of the initial concentration of the juice and the integrated temperature-time product.

The juice may be heated in the oven or autoclave until it is reduced to a thick dark brown tar-like consistency or until total dryness is achieved. The dried juice is reduced to fine powder or redissolved in water.

Step (f): Final pH Adjustment and Blending for Intended Use

The pH of the juice drops during step (e) by an amount proportional to the initial reducing sugar concentration and the integrated time-temperature product. It may fall to 4.0 or lower in juice having a higher sugar concentration. For beer-making purposes, potatoes having a high initial sugar concentration are used and clear juice from step (d) is blended with material from step (e) made from a volume of juice of step (d) equal to up to 20% of the total, depending on the browning technique used, to obtain a pH of 4.5 to 5.0. For making an instant coffee substitute, potatoes having an intermediate initial sugar concentration are used and the pH after step (e) is adjusted from around 4.5 to about 5.2-5.4 using sodium carbonate or sodium hydroxide. For making HVP substitute, potatoes having minimal initial sugar concentration are used, the final pH may be adjusted to between 5.0 and 6.0 and step (e) is discarded in favour of a “milder” treatment carried out in a vacuum oven at 50-60° C. to minimize thermal chemical reactions causing browning.

### EXAMPLES

The following are practical examples describing the treatment of potatoes and the production of novel food and beverage making ingredients using preferred embodiments of the process according to the invention.

### Example 1

Twenty kg of jumbo Superior variety potatoes stored for eight weeks at 1° C. were washed and peeled abrasively down to 17.1 kg, sliced longitudinally into four, dropped into 8.5 liters of 1.5% Na₂SO₃, passed through a kitchen model juicer and the starch-laden juice collected in a 30 cm wide Buchner funnel fitted with a nylon mesh overlayed with polyester cloth to retain starch. The ejected fiber was passed through the juicer three times. Using a vacuum pressure of 30 mm Hg, 11.0 liters of turbid juice was drawn through the starch bed. The juice was warmed to 50° C., brought to pH 5.0 with thoroughly washed hydrogen form cationic exchange resin (Bio-Rad AG 50W-X2 200 mesh) and drawn through a sterile polypropylene hollow fibre microfilter (0.15 m², 0.2μ) into a sterile 4-litre filter flask connected to vacuum and containing 1 ml of Dow Corning 1520US antifoam and a magnetic stirrer. The temperature of the liquid in the flask was held at 45° C., with constant stirring. After 24 hours, all of the juice had been drawn into the flask and had evaporated to a volume of about 2 liters. The vacuum was broken by connection to a nitrogen gas cylinder and the juice was heated in the filter flask to 70° C. for several minutes. About 0.4 liters of juice was filtered on a 12 cm wide Buchner funnel fitted with Whatman no. 4 filter paper. The remainder of the juice was then heated to 95° C. for several minutes and filtered using the same means. The pH of 200 ml of the juice heated to 95° C. prior to filtering was adjusted to 8.0 with NaOH and the juice autoclaved at 125° C. for 1.5 hours, producing a dark brown liquid having a pH of 4.8. The yellow clear juices obtained at both temperatures (1.7 liters total) had a pH of 5.3 and a reducing sugar concentration of about 25%. The dried masses of the precipitated proteins, fibers and starch were 64 g, 940 g, and 1.88 kg respectively.

High-maltose corn syrup, 2.70 kg, plus 1.5 kg of low dextrose equivalent corn syrup (80% solids) plus 0.85 1 of the juice heated to 95° C. prior to filtering plus the 200 ml of autoclaved juice were blended into tap water, brought to a volume of 25 liters and simmered at 100° C. in the steam-jacketed kettle covered with foil for 1.5 hours with pelleted hops (50 g) for bittering and infused for 15 minutes after boiling with an additional 30 g of pelleted hops for aroma during draining through three layers of polyester cloth, yielding 24 liters of potato wort.

A 150 ml portion of the juice heated to 70° C. prior to filtering was diluted to 600 ml, inoculated with a top-fermenting brewers yeast, incubated with agitation for 36 hours at 30° C. and then added to the wort cooled to 19° C. After five days of fermentation, the fermented wort was cooled to 4° C. overnight and then microfiltered into Spartansburg tanks previously purged with carbon dioxide and pressurized to 22 psi with carbon dioxide on three consecutive days of resting at 4° C. After two weeks at 4° C., the beer was tasted and found to resemble English brown ale, with caramel, molasses and chocolate notes. The foam head stability was close to that of a cream ale, persisting for several minutes.

### Example 2

Twenty kg of jumbo Superior variety potatoes stored for eight weeks at 1° C. were processed as in the previous example. High-maltose corn syrup, 2.5 kg, plus 1.5 kg of low dextrose equivalent corn syrup (80% solids) plus 1.05 1 of juice heated to 95° C. prior to filtering were blended into tap water, brought to a volume of 25 liters and simmered at 100° C., hopped as in the previous example, yielding 24 liters of potato wort.

The wort was cooled to 19° C., inoculated, fermented, cooled, microfiltered and pressLurized to produce beer as in the previous example. After two weeks at 4° C., the beer was tasted and found to resemble pale pilsener ale, with hop and yeast aromas dominating. The foam head dissipated within one minute but did not disappear.

### Example 3

Twenty kg of jumbo Superior variety potatoes stored for eight weeks at 1° C. were processed as in the previous examples and 24 liters of potato wort was obtained as in example 2. A 150 ml portion ofjuice heated to 95° C. and filtered was diluted to 600 ml, inoculated with a top-fermenting brewers yeast, incubated with agitation for 36 hours at 30° C. and then added to the wort cooled to 19° C. After five days of fermentation, the fermented wort was treated as in the previous examples. After two weeks at 4° C., the beer was tasted and found to resemble pale pilsener ale, with hop and yeast aromas dominating. The foam head consisted of larger bubbles than in the previous examples and disappeared within a minute after pouring.

### Example 4

Twenty kg of jumbo Superior variety potatoes stored for five weeks at 1° C. were processed as in example 1. The turbid juice was warmed to 55° C., brought to pH 5.0 with acetic acid and incubated for 24 hours with constant stirring at 55° C. with 0.5 g/l of Flavourzyme® in a 4-litre filter flask connected to vacuum and containing 1 ml of Dow Corning 1520US antifoam and a magnetic agitator. The vacuum was broken by connection to a nitrogen gas cylinder and the juice was heated in the filter flasks to 100° C. for several minutes and filtered on Whatman no. 4 filter paper. The dry mass of the precipitated protein was 82 g. The yellow clear juice obtained (1.4 liters total) had a pH of 5.9 and a reducing sugar concentration of about 15%.

The pH of the juice was adjusted to 8.0 with NaOH and placed in a shallow Teflon container in a drying oven at 125° C. for 12 hours, producing a dark brown, sponge-like dry swollen mass which was crushed into a fine powder and packaged. The mass of powder obtained was 490 g. A 10% solution of this powder in deionized water had a pH of 4.7. The powder was mixed thoroughly with 17.4 g of finely powdered sodium bicarbonate to bring this pH to 5.5.

Dissolving a level teaspoon of the brown powder-bicarbonate mixture in hot water yielded a liquid resembling coffee with a coffee-like aroma plus other, roasted flavour notes. This hot liquid melded very well with milk and table sugar to produce an enjoyable coffee-like beverage.

Using gas chromatographic analysis of the methylene chloride extract, the following substances were found in both the browned potato powder and a commercial instant freeze-dried coffee: methylpyrazine; butyrolactone; 2-hydroxy-3-methyl-2-cyclopentene-1-one; 5-(hydroxymethyl)-2-furancarboxaldehyde; furanmethanol; 1-(1Hpyrrol-2yl)-ethanone; maltol; 1-methyl-1H-pyrrol-2-carboxaldehyde; hexadecanoic acid.

The following additional substances were found in the commercial instant coffee only:

2-fulranmethanol acetate; 1-pyrrol-2-carboxaldehyde; furancarboxylic acid methyl ester; 4-hydroxy-2-methyl acetophenone; 1-(2,5-dihydroxyphenyl)-ethanone; caffeine.

The following additional substances were found in the browned potato powder only:

3-methyl-butanal; 2-methyl butanal; 2,5-dimethylpyrazine; trimethylpyrazine; nonanal; 1-(2-furanyl)-ethanone; 2,3-dihyro-3,5-dihydroxy-6-methyl-4H-pyran-4-one; 3-(maminobenzoyl)-2-methylpropionic acid; 1-acetyl-9H-pyrido(3,4b)indole.

### Example 5

Twenty kg of jumbo Superior variety potatoes stored for eight weeks at 24° C. were washed and peeled abrasively down to 16.2 kg, sliced longitudinally into four, dropped into 8.0 liters of 1.5% Na₂SO₃, passed through a kitchen model juicer and the starch-laden juice collected in a 30 cm wide Buchner funnel fitted with a nylon mesh overlayed with polyester cloth to retain starch. The ejected fibre was passed through the juicer three times. Using a vacuum pressure of 30 mm Hg, 9.1 liters of turbid juice was collected. The juice was warmed to 52° C., brought to pH 4.8 with hydrochloric acid and drawn through a sterile polypropylene hollow fibre microfilter (0.15 m², 0.2μ) into a sterile 4-litre filter flask connected to vacuum and containing 1 ml of Dow Corning 1520US antifoam and a magnetic agitator. Three grams of Flavourzyme® and 3 g of Enzeco glutaminase were added to the juice. The temperature of the liquid in the flasks was held at 50° C. After 24 hours, all of the juice had been drawn into the flask and had evaporated to a volume of about 2.0 liters. The juice was incubated for an additional 24 hours without continuous evacuation. The vacuum was then broken by connection to a nitrogen gas cylinder and the juice was heated in the filter flasks to 100° C. for several minutes. The yellow clear juice obtained had a pH of 5.2 and a reducing sugar concentration of about 2%. Glutamic acid made up 11% of the total free amino acids.

The dried masses of the precipitated protein, fibre and starch were 29 g, 1.14 kg, and 1.78 kg respectively.

The pH of the juice was adjusted to 6.0 with NaOH and the juice was freeze-dried and then vacuum dried at 55° C. for 24 hours. The resulting dried juice weighing 143 g was finely powdered with 50 g of sodium chloride. The beige-coloured powder had an HVP taste with a subtle french-fry flavour.

### Example 6

Sixteen kg of jumbo Superior variety potatoes stored for eight weeks at 24° C. and four kg of potatoes stored for eight weeks at 0° C. were processed as in the previous example. The yellow clear juice obtained had a pH of 5.1 and a reducing sugar concentration of about 5%. The pH of the juice was adjusted to 7.0 with NaOH and the juice was oven-dried at 100° C. in a large, shallow polypropylene dish for 12 hours. The resulting dried juice weighing 156 g was finely powdered with 50 g of sodium chloride. The light-brown coloured powder had an HVP taste with a roast-beef-like flavour.

Of course, numerous modifications obvious to those skilled in the art could be made to the process described above without going beyond the scope of the present invention as defined in the appended claim.

1. A process for the manufacture of at least one ingredient having a food and/or beverage application using potatoes as starting material, said process comprising the steps of:
a) cutting washed raw potatoes and dipping the so-cut potatoes in an anti-oxidant solution;
b) mechanically disintegrating the cut and dipped potatoes obtained in step a) to obtain a starch-containing juice and fibers, separating the fibers from the tarch-containing juice, and processing the starch-containing juice to extract the juice from the starch, said starch being in a non-gelatinized form;
c) subjecting the so-extracted juice to a slow evaporation with or without simultaneous addition of extra enzymes to produce small proteins and free amino acids from proteins contained in the juice;
d) heating the juice obtained in step c) to precipitate soluble proteins and to destroy enzymes contained in it, and separating by filtration the precipitated proteins from the juice to obtain a protein isolate and a filtered juice;
e) optionally further heating a portion of the filtered juice obtained in step d) to a temperature high enough to cause a Maillard browning reaction;
f) adjusting the pH of the juice(s) obtained in step d) and/or in optional step e) and, when a portion of the juice has been subjected to the heating in step e), blending said portion of the juice with the remainder of the juice obtained in step d) in a preselected ratio; and
g) recovering at least one of the following products:
(iv) the fiber obtained in step b), which is edible;
(v) the non-gelatinized starch produced in step b);
(vi) the protein isolate obtained in step d), which is edible; and
(iv) to (v) the juice obtained in step f) which:
when all the filtered juice obtained in step d) has been subjected to the further heating of step e), is useful to make a caffeine-free coffee substitute;
when none of the filtered juice obtained in step d) has been subjected to the further heating of step e), is useful as a hydrolyzed vegetable protein substitute; and
when a portion only of the filtered juice obtained in step d) has been subjected to the further heating of step e) and said portion has been blended with the remainder of the juice obtained in step d), is useful to make a fermentable wort to produce a malt-free beer.

2. The process of claim 1, wherein in step a), the anti-oxidant solution contains sulphurous anhydride dissolved in water.

3. The process of claim 1, wherein in step b), the mechanical disintegration and the fibers separation are carried out simultaneously in a centrifugal juicer.

4. The process of claim 3, wherein in step b), the extraction of the juice is carried out by filtration under vacuum.

5. The process of claim 1, wherein in step c), the slow evaporation is carried out by warming the extracted juice to a temperature of 45° C. to 60° C.

6. The process according of claim 5, wherein in step c), a cationic exchange resin is used to adjust the pH of the juice that is being warmed to between 4.0 and 5.5.

7. The process of claim 5, wherein in step c), the heat-treated juice obtained in step e) is used to adjust the pH of the juice that is being warmed to between 4.0 and 5.5.

8. The process of claim 5, wherein in step c), the juice after having been warmed, is sterilized by microfiltration and transferred to an incubation vessel.

9. The process of claim 8, wherein the juice that is being warmed, is subjected to an enzymatic treatment comprising a pH and temperature adjustment to allow the enzymes to hydrolyze the proteins contained in the juice during incubation.

10. The process of claim 8, wherein in step c), the juice transferred to the incubation vessel is subjected therein to a vacuum evaporation.

11. The process of claim 1, wherein in step d), the juice is heated to a temperature ranging between 60° and 100° C.

12. The process of claim 1, wherein in step e), the portion of the filtered juice is further heated in a drying oven.

13. The process of claim 1, wherein in step e), the portion of the filtered juice is further heated in an autoclave.

14. The process of claim 1, wherein in step f), the pH adjustment is carried out with an alkaline substance authorized for use in foods.

15. The process of claim 1, wherein:
in step a), the anti-oxidant solution contains sulphurous anhydride dissolved in water;
in step b), the mechanical disintegration and the fibers separation are carried out simultaneously in a centrifugal juicer and the extraction of the juice is carried out by filtration under vacuum;
in step c), the slow evaporation is carried out by warming the extracted juice to a temperature of 45° C. to 60° C. and the juice after having been warmed, is sterilized by microfiltration and transferred to an incubation vessel;
in step d), the juice is heated to a temperature ranging between 60° and 100° C.; and
in step f), the pH adjustment is carried out with an alkaline substance authorized for use in foods.

16. A coffee substitute prepared from potatoes by the process of claim 15.

17. A hydrolyzed vegetable protein substitute prepared from potatoes by the process of claim 15.

18. A malt-free beer made from a potato-based wort prepared by the process of claim 15.
